(19) United States
(12) Patent Application Publication
(10) Pub. No.: US 2024/0120135 A1
(43) Pub. Date: Apr. 11, 2024

(54) SOFT MAGNETIC POWDER, DUST CORE, MAGNETIC ELEMENT, AND ELECTRONIC DEVICE

(71) Applicant: SEIKO EPSON CORPORATION, TOKYO (JP)

(72) Inventor: Toshiki SANO, Hachinohe-shi (JP)

(21) Appl. No.: 18/480,580

(22) Filed: Oct. 4, 2023

(30) Foreign Application Priority Data
Oct. 7, 2022 (JP) 2022-162439

(51) Int. Cl. H01F 1/147; B22F 3/02; B22F 3/24; B22F 9/04; B22F 9/08; C22C 38/00; C22C 38/34

(52) U.S. Cl. CPC H01F 1/14766; B22F 3/02; B22F 3/24; B22F 9/04; B22F 9/082; C22C 38/002; C22C 38/34; H01F 27/255

(57) ABSTRACT

A soft magnetic powder contains: Fe as a main component; Si having a content of 2.5 mass % or more and 6.5 mass % or less; Cr having a content of 1.0 mass % or more and 10.0 mass % or less; S having a content of 0.0020 mass % or more and 0.0070 mass % or less; and impurities. A ratio A/B is 3000 or more and 8000 or less, where A [ppm] is an oxygen content in terms of mass ratio and B [m²/g] is a specific surface area.

The present application is based on, and claims priority from JP Application Serial Number 2022-162439, filed Oct. 7, 2022, the disclosure of which is hereby incorporated by reference herein in its entirety.

### BACKGROUND

### 1. Technical Field

The present disclosure relates to a soft magnetic powder, a dust core, a magnetic element, and an electronic device.

### 2. Related Art

JP-A-2020-111826 discloses a crystalline iron-based soft magnetic alloy powder containing 0.5 wt % to 10 wt % of Si, 0 wt % to 7 wt % of Cr, 0.01 wt % to 1.2 wt % of Al, and 0.001 wt % to 0.01 wt % of Ca, a balance being Fe and inevitable impurities. Since such an iron-based soft magnetic alloy powder has high fluidity, high filling can be obtained during molding. Therefore, high magnetic permeability is achieved in a magnetic element having a dust core.

In the iron-based soft magnetic alloy powder disclosed in JP-A-2020-111826, A1 is added for the purpose of improving a shape of the powder and for the purpose of reducing an amount of oxygen in the powder. Ca is added for the purpose of reducing the amount of oxygen in the powder. However, these elements cause deterioration of magnetic properties of the powder. In addition, when the amount of oxygen is too low, insulation between particles decreases, which causes a withstand voltage of the magnetic element to decrease.

### SUMMARY

A soft magnetic powder according to an application example of the present disclosure contains: Fe as a main component; Si having a content of 2.5 mass % or more and 6.5 mass % or less; Cr having a content of 1.0 mass % or more and 10.0 mass % or less; S having a content of 0.0020 mass % or more and 0.0070 mass % or less; and impurities. A ratio A/B is 3000 or more and 8000 or less, where A [ppm] is an oxygen content in terms of mass ratio and B [m²/g] is a specific surface area.

A dust core according to an application example of the disclosure contains: the soft magnetic powder according to the application example of the disclosure.

A magnetic element according to an application example of the disclosure includes: the dust core according to the application example of the disclosure.

An electronic device according to an application example of the disclosure includes: the magnetic element according to the application example of the disclosure.

### BRIEF DESCRIPTION OF THE DRAWINGS

FIG. 1 is a plan view schematically showing a toroidal type coil component.

FIG. 2 is a transparent perspective view schematically showing a closed magnetic circuit type coil component.

FIG. 3 is a perspective view showing a mobile personal computer which is an electronic device including a magnetic element according to an embodiment.

FIG. 4 is a plan view showing a smartphone which is an electronic device including the magnetic element according to the embodiment.

FIG. 5 is a perspective view showing a digital still camera which is an electronic device including the magnetic element according to the embodiment.

### DESCRIPTION OF EMBODIMENTS

Hereinafter, a soft magnetic powder, a dust core, a magnetic element, and an electronic device according to the disclosure will be described in detail based on a preferred embodiment shown in the accompanying drawings.

### 1. Soft Magnetic Powder

The soft magnetic powder according to an embodiment is a metal powder that exhibits soft magnetism. Such a soft magnetic powder can be applied to any application, and for example, is used for producing various green compacts such as dust cores and electromagnetic wave absorbers in which particles are bound to each other via a binder.

Materials of the soft magnetic powder include Fe (iron) as a main component, Si (silicon) having a content of 2.5 mass % or more and 6.5 mass % or less, Cr (chromium) having a content of 1.0 mass % or more and 10.0 mass % or less, S (sulfur) having a content of 0.0020 mass % or more and 0.0070 mass % or less, and impurities.

The main component refers to an element having the highest content in an atomic ratio. Fe is a main component of the soft magnetic powder and greatly affects the basic magnetic properties of the soft magnetic powder.

A content of Fe is not particularly limited, and is preferably 80 mass % or more, and more preferably 90 mass % or more.

The content of Si is 2.5 mass % or more and 6.5 mass % or less, preferably 2.7 mass % or more and 5.0 mass % or less, and more preferably 3.0 mass % or more and 4.5 mass % or less. When the content of Si is within the above range, a green compact having higher magnetic permeability can be obtained. When the content of Si is less than the lower limit value, the magnetic permeability decreases. On the other hand, when the content of Si exceeds the upper limit value, the material becomes hard, so that particles of the soft magnetic powder are brittle or are less likely to be deformed during compaction.

The content of Cr is 1.0 mass % or more and 10.0 mass % or less, preferably 3.0 mass % or more and 6.0 mass % or less, and more preferably 4.0 mass % or more and 5.0 mass % or less. When the content of Cr is within the above range, oxidation resistance of the soft magnetic powder can be enhanced. Accordingly, it is possible to obtain a soft magnetic powder in which an occupancy rate of oxides is reduced to a particularly low level during compaction. When the content of Cr is less than the lower limit value, the oxidation resistance of the soft magnetic powder decreases. On the other hand, when the content of Cr exceeds the upper limit value, the magnetic properties such as magnetic permeability decrease.

The content of S is 0.0020 mass % or more and 0.0070 mass % or less, preferably 0.0030 mass % or more and 0.0060 mass % or less, and more preferably 0.0040 mass % or more and 0.0050 mass % or less. The content of S affects an oxygen content and a particle shape of the soft magnetic powder. Specifically, the oxygen content of the soft magnetic powder tends to be proportional to the content of S. In addition, the particle shape changes depending on the content of S. When the content of S is within the above range, the oxygen content of the soft magnetic powder can be adjusted to an optimum range, and the particle shape can be brought close to a sphere. When the content of S is less than the lower limit value, the oxygen content in the soft magnetic powder is too low. As a result, the insulation between the particles of the soft magnetic powder decreases, and the withstand voltage of the green compact obtained by compacting the soft magnetic powder decreases. In addition, the particle shape of the soft magnetic powder tends to be irregular, and a density of the green compact decreases. As a result, the magnetic properties such as magnetic permeability of the green compact decrease. On the other hand, when the content of S exceeds the upper limit value, the oxygen content of the soft magnetic powder is too high. As a result, the occupancy rate of the oxides is increased in the green compact obtained by compacting the soft magnetic powder, and the magnetic properties such as magnetic permeability decrease.

A concentration of the impurities is preferably 0.10 mass % or less, and more preferably 0.05 mass % or less for each element. In addition, a total concentration of the impurities is preferably 1.00 mass % or less. Within this range, an element that is inevitably mixed or an element that is intentionally added can be regarded as an impurity since an effect of the soft magnetic powder is not affected.

The soft magnetic powder according to the embodiment contains a predetermined amount of oxygen. The oxygen content in terms of mass ratio in the soft magnetic powder is A [ppm]. A specific surface area of the soft magnetic powder is B [m²/g]. At this time, in the soft magnetic powder according to the embodiment, a ratio A/B satisfies 3000 or more and 8000 or less.

According to such a configuration, a soft magnetic powder in which the oxygen content relative to the specific surface area is optimized is obtained. The specific surface area mainly depends on a particle diameter of the soft magnetic powder. Therefore, if the ratio A/B is within the above range, a soft magnetic powder in which the oxygen content is optimized according to the particle diameter can be implemented. As a result, it is possible to obtain a soft magnetic powder in which the occupancy rate of the oxides in the green compact is reduced and the insulation between the particles is secured. That is, with the soft magnetic powder according to the embodiment, it is possible to produce a green compact having excellent magnetic properties such as magnetic permeability and a sufficiently high withstand voltage.

The ratio A/B is preferably 4000 or more and 7500 or less, and more preferably 5000 or more and 7000 or less.

When the ratio A/B is less than the lower limit value, a ratio of the oxygen content to the specific surface area of the soft magnetic powder is too low. Therefore, the insulation between the particles decreases. On the other hand, when the ratio A/B exceeds the upper limit value, the ratio of the oxygen content to the specific surface area of the soft magnetic powder is too high. Therefore, the magnetic properties such as magnetic permeability in the green compact decrease.

The oxygen content A is preferably 1500 ppm or more and 2400 ppm or less, and more preferably 1600 ppm or more and 2000 ppm or less. When the oxygen content A is within the above range, the oxygen content A is optimized in a soft magnetic powder having a relatively small average particle diameter. Accordingly, even in a soft magnetic powder having a small particle diameter, it is possible to produce a green compact having excellent magnetic properties such as magnetic permeability, and it is possible to sufficiently secure the insulation between the particles. Further, in such a green compact, since the particle diameter of the soft magnetic powder is small, a loss caused by an eddy current is easily prevented.

The specific surface area B is preferably 0.20 m²/g or more and 0.45 m²/g or less, more preferably 0.25 m²/g or more and 0.40 m²/g or less, and still more preferably 0.28 m²/g or more and 0.36 m²/g or less. When the specific surface area B is within the above range, a filling property of the soft magnetic powder is improved, and a density of the green compact can be increased. When the specific surface area B is less than the lower limit value, the particle diameter of the soft magnetic powder may be too large. On the other hand, when the specific surface area B exceeds the upper limit value, the filling property of the soft magnetic powder may decrease, and the density of the green compact may decrease.

The specific surface area B is obtained by a BET method. As a device for measuring the specific surface area B, for example, a BET specific surface area measurement device HM1201-010 manufactured by Mountech Co., Ltd. is used, and an amount of a sample is 5 g.

The above composition is identified by the following analysis method.

Examples of the analysis method include iron and steel-atomic absorption spectrometry defined in JIS G 1257:2000, iron and steel-ICP emission spectrometry defined in JIS G 1258:2007, iron and steel-spark discharge emission spectrometry defined in JIS G 1253:2002, iron and steel-fluorescent X-ray spectrometry defined in JIS G 1256:1997, and gravimetric, titration and absorption spectrometric methods defined in JIS G 1211 to JIS G 1237.

Specifically, examples include a solid-state emission spectrometer manufactured by SPECTRO Corporation, particularly a spark discharge emission spectrometer, model: SPECTROLAB, type: LAVMB08A, and an ICP device CIROS 120 manufactured by Rigaku Corporation.

In particular, in order to identify C (carbon) and S (sulfur), an oxygen flow combustion (high-frequency induction heating furnace combustion)-infrared absorption method defined in JIS G 1211:2011 is also used. Specifically, examples include a carbon-sulfur elemental analyzer CS-200 manufactured by LECO Corporation.

Further, in particular, in order to identify N (nitrogen) and O (oxygen), iron and steel-methods for determination of nitrogen content defined in JIS G 1228:1997 and general rules for determination of oxygen in metallic materials defined in JIS Z 2613:2006 are also used. Specifically, examples include an oxygen-nitrogen elemental analyzer TC-300/EF-300 manufactured by LECO Corporation and an oxygen-nitrogen-hydrogen elemental analyzer ONH836 manufactured by LECO Corporation.

An average particle diameter of the soft magnetic powder is not particularly limited, and is preferably 1.0 μm or more and 20.0 μm or less, more preferably 3.0 μm or more and 15.0 μm or less, and still more preferably 5.0 μm or more and 12.0 μm or less. Accordingly, it is possible to obtain a soft magnetic powder that has a high filling property during compaction and that can prevent an eddy current loss in the green compact.

When the average particle diameter of the soft magnetic powder is less than the lower limit value, the soft magnetic powder tends to aggregate depending on a particle size distribution of the soft magnetic powder, and the density of the green compact may decrease. On the other hand, when the average particle diameter of the soft magnetic powder exceeds the upper limit value, the eddy current loss in the green compact obtained by compacting the soft magnetic powder may increase depending on the particle size distribution of the soft magnetic powder.

The average particle diameter refers to a particle diameter D50 where a cumulative frequency is 50% from a small-diameter side in a cumulative particle size distribution on a volume basis of the soft magnetic powder obtained using a laser diffraction type particle size distribution measurement device.

An insulating film may be provided on surfaces of the particles of the soft magnetic powder as necessary. By providing such an insulating film, the insulation between the particles of the soft magnetic powder can be enhanced. As a result, the eddy current flowing through the particles can be reduced, and the eddy current loss in the green compact can be reduced.

Examples of the insulating film include a glass material, a ceramic material, and a resin material.

When formed into a green compact, the soft magnetic powder according to the embodiment preferably has magnetic permeability of 35.3 or more, more preferably 35.5 or more, and still more preferably 36.0 or more at a measurement frequency of 100 kHz. Such a soft magnetic powder can implement a green compact having high magnetic permeability.

The magnetic permeability of the green compact is, for example, relative magnetic permeability obtained based on self-inductance of a magnetic core coil having a closed magnetic circuit in which the green compact has a toroidal shape, that is, effective magnetic permeability. For the measurement of the magnetic permeability, an impedance analyzer is used, and a measurement frequency is 100 kHz. In addition, the number of turns of winding is 7, and a wire diameter of the winding is 0.6 mm. A size of the green compact is set to an outer diameter of 04 mm, an inner diameter of φ8 mm, and a thickness of 3 mm, and a molding pressure is set to 294 MPa.

### 2. Effect of Embodiment

As described above, the soft magnetic powder according to the embodiment contains Fe, Si, Cr, S, and impurities. Fe is a main component. The content of Si is 2.5 mass % or more and 6.5 mass % or less. The content of Cr is 1.0 mass % or more and 10.0 mass % or less. The content of S is 0.0020 mass % or more and 0.0070 mass % or less. The soft magnetic powder according to the embodiment has a ratio A/B of 3000 or more and 8000 or less, where A [ppm] is an oxygen content in terms of mass ratio and B [m²/g] is a specific surface area.

According to such a configuration, it is possible to produce a green compact in which an occupancy rate of oxides is reduced during compaction and magnetic properties are excellent, and it is possible to obtain a soft magnetic powder in which insulation between particles is secured. That is, according to the soft magnetic powder as described above, it is possible to produce a green compact having excellent magnetic properties and a sufficiently high withstand voltage.

In the soft magnetic powder according to the embodiment, the oxygen content A in terms of mass ratio is 1500 ppm or more and 2400 ppm or less. Accordingly, the oxygen content A is optimized in a soft magnetic powder having a relatively small average particle diameter. As a result, even in a soft magnetic powder having a small particle diameter, it is possible to produce a green compact having excellent magnetic properties such as magnetic permeability, and it is possible to sufficiently secure the insulation between the particles. Further, in such a green compact, since the particle diameter of the soft magnetic powder is small, a loss caused by an eddy current is easily prevented.

In the soft magnetic powder according to the embodiment, the average particle diameter is preferably 1.0 μm or more and 20.0 μm or less. Accordingly, it is possible to obtain a soft magnetic powder that has a high filling property during compaction and that can prevent an eddy current loss in the green compact.

In the soft magnetic powder according to the embodiment, the content of Si is preferably 3.0 mass % or more and 4.5 mass % or less, and the content of Cr is preferably 3.0 mass % or more and 6.0 mass % or less. Accordingly, it is possible to produce a green compact having higher magnetic permeability, and a soft magnetic powder having excellent oxidation resistance can be obtained.

### 3. Production Method for Soft Magnetic Powder

Next, an example of a production method for the soft magnetic powder described above will be described.

The soft magnetic powder may be a powder produced by any method. Examples of the production method include a pulverization method, in addition to various atomization methods such as a water atomization method, a gas atomization method, and a rotary water atomization method. Among these, the soft magnetic powder is preferably a powder produced by an atomization method. According to the atomization method, it is possible to efficiently produce a high-quality metal powder having a particle shape that is closer to a true sphere and with less formation of oxides and the like. Therefore, a metal powder having a small specific surface area can be produced by the atomization method.

The atomization method is a method of producing a metal powder by causing a molten metal to collide with a liquid or a gas injected at a high speed to pulverize and cool the molten metal. In the atomization method, since spheroidization is performed during the process of solidification after the molten metal is micronized, particles close to a true sphere can be produced.

Among these, the water atomization method is a method of producing a metal powder from a molten metal by using a liquid such as water as a cooling liquid, injecting the liquid in an inverted conical shape that converges the liquid to one point, and causing the molten metal to flow down toward the convergence point and to collide with the liquid.

In addition, the rotary water atomization method is a method of producing a metal powder by supplying a cooling liquid along an inner peripheral surface of a cooling cylinder, swirling the cooling liquid along the inner peripheral surface, spraying a jet of a liquid or a gas to a molten metal, and taking the scattered molten metal into the cooling liquid.

Further, the gas atomization method is a method of producing a metal powder from a molten metal by using a gas as a cooling medium, injecting the gas in an inverted conical shape that converges the gas to one point, and causing the molten metal to flow down toward the convergence point and collide with the gas.

In addition, the produced soft magnetic powder may be classified as necessary. Examples of the classification method include dry classification such as sieving classification, inertial classification, and centrifugal classification, and wet classification such as sedimentation classification.

### 4. Dust Core and Magnetic Element

Next, the dust core and the magnetic element according to the embodiment will be described.

The magnetic element according to the embodiment can be applied to various magnetic elements including a magnetic core, such as a choke coil, an inductor, a noise filter, a reactor, a transformer, a motor, an actuator, an electromagnetic valve, and a generator. The dust core according to the embodiment is applicable to the magnetic core in these magnetic elements. Hereinafter, two types of coil components will be representatively described as an example of the magnetic element.

### 4.1. Toroidal Type

First, a toroidal type coil component which is an example of the magnetic element according to the embodiment will be described.

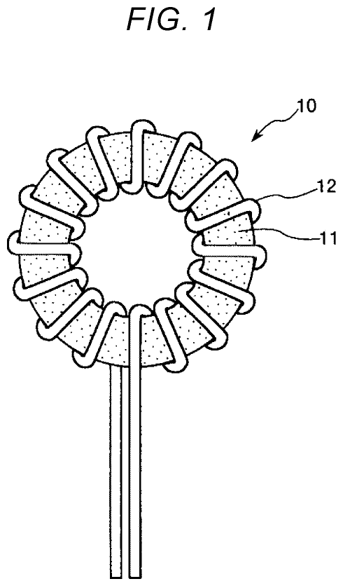

FIG. 1 is a plan view schematically showing the toroidal type coil component.

A coil component 10 shown in FIG. 1 includes a ring-shaped dust core 11 and a conductive wire 12 wound around the dust core 11. Such a coil component 10 is generally referred to as a toroidal coil.

The dust core 11 is obtained by mixing the soft magnetic powder according to the embodiment and a binder, supplying the obtained mixture to a mold, and pressing and molding the mixture. Therefore, the dust core 11 is a green compact containing the soft magnetic powder according to the embodiment. In such a dust core 11, since the occupancy rate of oxides is reduced, the magnetic properties are excellent. Since the insulation between particles is high, the dust core 11 having a high withstand voltage can be obtained. Therefore, the coil component 10 including the dust core 11 has excellent magnetic properties such as magnetic permeability and a magnetic flux density, and has a high withstand voltage. Therefore, when the coil component 10 is mounted on an electronic device or the like, it is possible to achieve high performance and miniaturization of the electronic device or the like.

Examples of materials of the binder used in production of the dust core 11 include organic materials such as silicone-based resins, epoxy-based resins, phenol-based resins, polyamide-based resins, polyimide-based resins, and polyphenylene-sulfide-based resins, and inorganic materials such as phosphates such as magnesium phosphate, calcium phosphate, zinc phosphate, manganese phosphate, and cadmium phosphate, and silicates such as sodium silicate, and, in particular, a thermosetting polyimide or an epoxy-based resin is preferable. These resin materials are easily cured by being heated and have excellent heat resistance. Therefore, ease of production and heat resistance of the dust core 11 can be improved.

A ratio of the binder to the soft magnetic powder slightly varies depending on target magnetic properties and mechanical properties, an allowable eddy current loss and the like of the dust core 11 to be produced, and is preferably about 0.3 mass % or more and 5.0 mass % or less, more preferably about 0.5 mass % or more and 3.0 mass % or less, and still more preferably about 0.7 mass % or more and 2.0 mass % or less. Accordingly, the coil component 10 having excellent magnetic properties can be obtained while particles of the soft magnetic powder are sufficiently bound to each other.

If necessary, various additives may be added to the mixture for any purpose as necessary.

Examples of a constituent material of the conductive wire 12 include materials having high conductivity, for example, metal materials including Cu, Al, Ag, Au, and Ni. In addition, an insulating film may be provided on a surface of the conductive wire 12 as necessary.

A shape of the dust core 11 is not limited to the ring shape shown in FIG. 1, and may be, for example, a shape in which a part of the ring is missing, a shape in which the shape in a longitudinal direction is linear, a sheet shape, a film shape, or the like.

The dust core 11 may contain, as necessary, a soft magnetic powder other than the soft magnetic powder according to the embodiment described above, or a non-magnetic powder.

### 4.2. Closed Magnetic Circuit Type

Next, a closed magnetic circuit type coil component which is an example of the magnetic element according to the embodiment will be described.

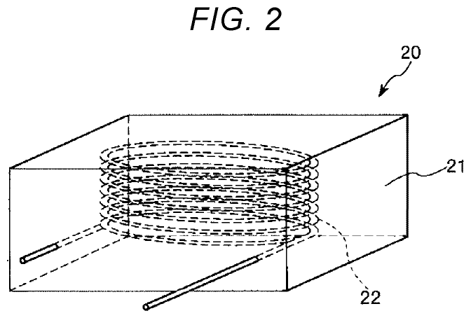

FIG. 2 is a transparent perspective view schematically showing the closed magnetic circuit type coil component.

Hereinafter, the closed magnetic circuit type coil component will be described, and, in the following description, differences from the toroidal type coil component will be mainly described, and description of the same matters will be omitted.

As shown in FIG. 2, a coil component 20 according to the embodiment is formed by embedding a conductive wire 22 formed in a coil shape in a dust core 21. That is, the coil component 20 that is a magnetic element includes the dust core 21 containing the above-described soft magnetic powder, and is formed by molding the conductive wire 22 with the dust core 21. The dust core 21 has a configuration same as that of the dust core 11 described above. Accordingly, it is possible to implement the coil component 20 having excellent magnetic properties such as magnetic permeability and a magnetic flux density and a high withstand voltage.

The coil component 20 having such a configuration can be relatively easily miniaturized. Therefore, when the coil component 20 is mounted on an electronic device or the like, it is possible to achieve high performance and miniaturization of the electronic device or the like.

In addition, since the conductive wire 22 is embedded in the dust core 21, a gap is less likely to be formed between the conductive wire 22 and the dust core 21. Therefore, vibration caused by magnetostriction of the dust core 21 can be prevented, and generation of noise due to the vibration can also be prevented.

A shape of the dust core 21 is not limited to the shape shown in FIG. 2, and may be a sheet shape, a film shape, or the like.

The dust core 21 may contain, as necessary, a soft magnetic powder other than the soft magnetic powder according to the embodiment described above, or a non-magnetic powder.

### 5. Electronic Device

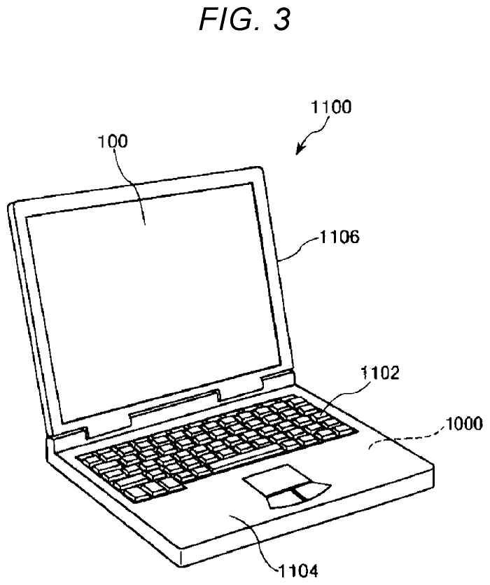

Next, an electronic device including the magnetic element according to the embodiment will be described with reference to FIGS. 3 to 5.

FIG. 3 is a perspective view showing a mobile personal computer which is an electronic device including the magnetic element according to the embodiment. A personal computer 1100 shown in FIG. 3 includes a main body 1104 including a keyboard 1102 and a display unit 1106 including a display 100. The display unit 1106 is supported via a hinge structure to be pivotable with respect to the main body 1104. Such a personal computer 1100 includes therein a magnetic element 1000 such as a choke coil, an inductor, or a motor for a switching power supply.

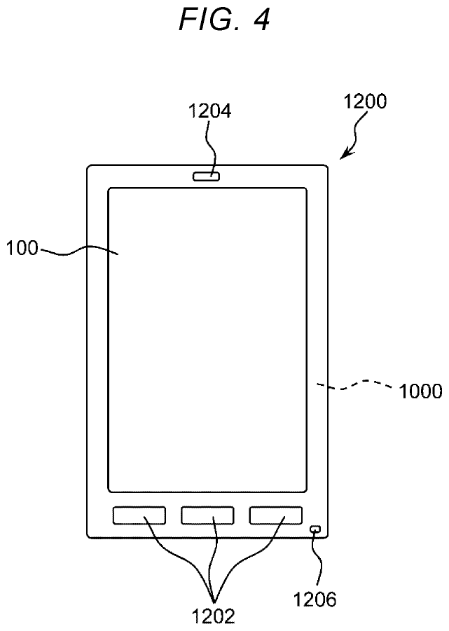

FIG. 4 is a plan view showing a smartphone which is an electronic device including the magnetic element according to the embodiment. A smartphone 1200 shown in FIG. 4 includes a plurality of operation buttons 1202, an earpiece 1204, and a mouthpiece 1206. The display 100 is disposed between the operation buttons 1202 and the earpiece 1204. Such a smartphone 1200 includes therein the magnetic element 1000 such as an inductor, a noise filter, or a motor.

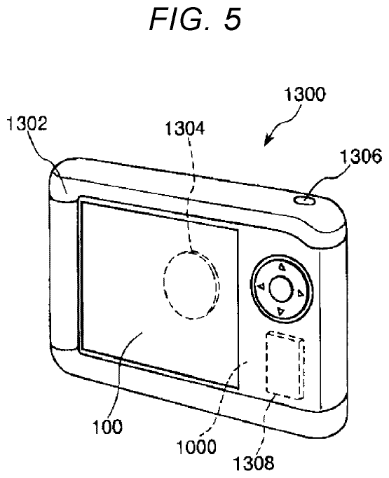

FIG. 5 is a perspective view showing a digital still camera which is an electronic device including the magnetic element according to the embodiment. A digital still camera 1300 photoelectrically converts an optical image of a subject by an imaging element such as a charge coupled device (CCD) to generate an imaging signal.

The digital still camera 1300 shown in FIG. 5 includes the display 100 provided on a rear surface of a case 1302. The display 100 functions as a finder that displays the subject as an electronic image. In addition, a light receiving unit 1304 including an optical lens, a CCD, or the like is provided on a front surface side of the case 1302, that is, on a back surface side in the drawing.

When a photographer checks a subject image displayed on the display 100 and presses a shutter button 1306, a CCD imaging signal at that time is transferred to and stored in a memory 1308. Such a digital still camera 1300 also includes therein the magnetic element 1000 such as an inductor or a noise filter.

Examples of the electronic device according to the embodiment include, in addition to the personal computer in FIG. 3, the smartphone in FIG. 4, and the digital still camera in FIG. 5, a mobile phone, a tablet terminal, a watch, an ink jet discharge device such as an ink jet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, a medical device (such as an electronic thermometer, a blood pressure meter, a blood glucose meter, an electrocardiogram measuring device, an ultrasonic diagnostic device, or an electronic endoscope), a fish finder, various measuring devices, instruments for a vehicle, an aircraft, and a ship, a vehicle control device (such as an automobile control device, an aircraft control device, a railway vehicle control device, or a ship control device), and a flight simulator.

As described above, such an electronic device includes the magnetic element according to the embodiment. Accordingly, it is possible to obtain the effect of the magnetic element having excellent magnetic properties and a high withstand voltage, and it is possible to achieve high performance and miniaturization of the electronic device.

The soft magnetic powder, the dust core, the magnetic element, and the electronic device according to the disclosure are described above based on the preferred embodiment, and the disclosure is not limited thereto. For example, shapes of the dust core and the magnetic element are not limited to shapes shown in the drawings, and may be any shape.

### EXAMPLES

Next, specific examples of the disclosure will be described.

### 6. Production of Soft Magnetic Powder

### 6.1. Sample No. 1

First, a soft magnetic powder was obtained by a water atomization method. Composition of the obtained soft magnetic powder is as shown in Table 1. In the water atomization method, an angle between the injected water and the molten metal flowing down was 30 degrees. A temperature of the molten metal was 50° C. higher than a melting point of a raw material.

An average particle diameter, an oxygen content A, and a specific surface area B of the obtained soft magnetic powder were measured. A ratio A/B was calculated. Measurement results and calculation results are shown in Table 1.

### 6.2. Sample Nos. 2 to 20

Soft magnetic powders were obtained in the same manner as in Sample No. 1 except that the compositions of the soft magnetic powders were changed as shown in Table 1 or Table 2.

### 6.3. Sample No. 21

A soft magnetic powder was obtained in the same manner as in Sample No. 1 except that the composition of the soft magnetic powder was changed as shown in Table 2, and the soft magnetic powder immediately after production was stored under a nitrogen atmosphere to prevent oxidation.

### 6.4. Sample No. 22

A soft magnetic powder was obtained in the same manner as in Sample No. 1 except that the composition of the soft magnetic powder was changed as shown in Table 2, and the soft magnetic powder immediately after the production was stored in a high humidity environment to promote oxidation.

In Tables 1 and 2, among the soft magnetic powders of the sample Nos., those corresponding to the disclosure are referred to as “Examples”, and those not corresponding to the disclosure are referred to as “Comparative Examples”.

TABLE 1

| | | | | | | | | | | Evaluation of soft magnetic powder | | | |
|---|---|---|---|---|---|---|---|---|---|---|---|---|---|
| | | Configuration of soft magnetic powder | | | | | | | | | Magnetic | | Electrical |
| | | | | | | Average | Oxygen | Specific | | Density | permeability | | resistance |
| | | Composition | | | | particle | content | surface | Ratio | of green | of green | | value of green |
| | | Fe | Si | Cr | S | diameter | A | area B | A/B | compact | compact | | compact |
| Sample No. | | mass % | | | | μm | ppm | m²/g | — | g/cm³ | — | — | — |
| No. 1 | Comparative | Balance | 3.5 | 4.5 | 0.0005 | 10.0 | 1400 | 0.41 | 3415 | 5.50 | 34.7 | D | — |
| | Example | | | | | | | | | | | | |
| No. 2 | Comparative | Balance | 3.5 | 4.5 | 0.0010 | 10.0 | 1450 | 0.30 | 4833 | 5.52 | 34.9 | D | C |
| | Example | | | | | | | | | | | | |
| No. 3 | Comparative | Balance | 3.5 | 4.5 | 0.0015 | 10.0 | 1470 | 0.30 | 4900 | 5.55 | 35.2 | D | C |
| | Example | | | | | | | | | | | | |
| No. 4 | Example | Balance | 3.5 | 4.5 | 0.0020 | 10.0 | 1500 | 0.30 | 5000 | 5.65 | 35.5 | B | B |
| No. 5 | Example | Balance | 3.5 | 4.5 | 0.0030 | 10.0 | 1550 | 0.30 | 5167 | 5.67 | 35.8 | B | B |
| No. 6 | Example | Balance | 3.5 | 4.5 | 0.0040 | 10.0 | 1600 | 0.30 | 5333 | 5.72 | 36.2 | A | A |
| No. 7 | Example | Balance | 3.5 | 4.5 | 0.0050 | 10.0 | 1700 | 0.30 | 5667 | 5.75 | 36.4 | A | A |
| No. 8 | Example | Balance | 3.5 | 4.5 | 0.0060 | 10.0 | 1800 | 0.30 | 6000 | 5.76 | 36.6 | A | A |
| No. 9 | Example | Balance | 3.5 | 4.5 | 0.0065 | 10.0 | 2000 | 0.30 | 6667 | 5.72 | 36.0 | A | A |
| No. 10 | Example | Balance | 3.5 | 4.5 | 0.0070 | 10.0 | 2400 | 0.40 | 6000 | 5.67 | 35.7 | B | A |
| No. 11 | Comparative | Balance | 3.5 | 4.5 | 0.0080 | 10.0 | 2600 | 0.43 | 6047 | 5.62 | 35.2 | D | A |
| | Example | | | | | | | | | | | | |
| No. 12 | Comparative | Balance | 3.5 | 4.5 | 0.0100 | 10.0 | 3000 | 0.45 | 6667 | 5.56 | 34.5 | D | A |
| | Example | | | | | | | | | | | | |
| No. 13 | Comparative | Balance | 3.5 | 4.5 | 0.0130 | 10.0 | 3300 | 0.46 | 7174 | 5.55 | 34.5 | D | A |
| | Example | | | | | | | | | | | | |

TABLE 2

| | | | | | | | | | | Evaluation of soft magnetic powder | | | |
|---|---|---|---|---|---|---|---|---|---|---|---|---|---|
| | | Configuration of soft magnetic powder | | | | | | | | | Magnetic | | Electrical |
| | | | | | | Average | Oxygen | Specific | | Density | permeability | | resistance |
| | | Composition | | | | particle | content | surface | Ratio | of green | of green | | value of green |
| | | Fe | Si | Cr | S | diameter | A | area B | A/B | compact | compact | | compact |
| Sample No. | | mass % | | | | μm | ppm | m²/g | — | g/cm³ | — | — | — |
| No. 14 | Example | Balance | 3.0 | 4.5 | 0.0050 | 10.0 | 1500 | 0.30 | 5000 | 5.76 | 36.0 | A | B |
| No. 15 | Example | Balance | 4.5 | 4.5 | 0.0040 | 10.0 | 1550 | 0.30 | 5167 | 5.75 | 36.0 | A | B |
| No. 16 | Example | Balance | 3.5 | 3.5 | 0.0050 | 10.0 | 2000 | 0.30 | 6667 | 5.72 | 36.4 | A | A |
| No. 17 | Example | Balance | 3.5 | 5.5 | 0.0040 | 10.0 | 1500 | 0.30 | 5000 | 5.78 | 36.8 | A | B |
| No. 18 | Example | Balance | 2.5 | 8.5 | 0.0030 | 10.0 | 1800 | 0.30 | 6000 | 5.71 | 35.5 | B | B |
| No. 19 | Example | Balance | 3.5 | 4.5 | 0.0020 | 4.0 | 2400 | 0.42 | 5714 | 5.60 | 35.3 | C | B |
| No. 20 | Example | Balance | 3.5 | 4.5 | 0.0030 | 12.0 | 2000 | 0.28 | 7143 | 5.76 | 36.6 | A | A |
| No. 21 | Comparative | Balance | 3.5 | 4.5 | 0.0020 | 10.0 | 800 | 0.30 | 2667 | 5.79 | 35.4 | C | C |
| | Example | | | | | | | | | | | | |
| No. 22 | Comparative | Balance | 3.5 | 4.5 | 0.0045 | 10.0 | 4500 | 0.45 | 10000 | 5.76 | 33.5 | D | A |
| | Example | | | | | | | | | | | | |

### 7. Evaluation of Soft Magnetic Powder

### 7.1. Density of Green Compact

The soft magnetic powder of each sample No. was used to produce a green compact as follows.

First, the soft magnetic powder, an epoxy resin (a binder), and methyl ethyl ketone (an organic solvent) were mixed to obtain a mixed material. An amount of the epoxy resin added was 1 mass % with respect to the soft magnetic powder.

Next, the obtained mixed material was stirred and then dried by heating at a temperature of 150° C. for 30 minutes to obtain a massive dried body. Next, the dried body was sieved with a sieve having an opening of 600 μm, and the dried body was pulverized, to obtain a granulated powder.

Next, a mold is filled with the obtained granulated powder, and a molded product was obtained based on the following molding conditions.

Molding method: press molding

Shape of molded product: ring shape

Dimensions of molded product: outer diameter: φ14 mm, inner diameter: φ8 mm, thickness: 3 mm

Molding pressure: 294 MPa

Next, the binder in the molded product was heated to be cured. Accordingly, a green compact was obtained.

Next, a mass of the obtained green compact was measured, and a density of the green compact was calculated based on the measured mass and a volume of the molded product. Calculation results are shown in Tables 1 and 2.

### 7.2. Magnetic Permeability of Green Compact

With respect to the green compact produced using the soft magnetic powder of each sample No., magnetic permeability was measured by the method described above. Measurement results are shown in Tables 1 and 2.

The calculated magnetic permeability was evaluated in light of the following evaluation criteria. Evaluation results are shown in Tables 1 and 2.

A: the magnetic permeability is 36.0 or more.

B: the magnetic permeability is 35.5 or more and less than 36.0.

C: the magnetic permeability is 35.3 or more and less than 35.5.

D: the magnetic permeability is less than 35.3.

### 7.3. Electrical Resistance Value of Green Compact

With respect to the green compact produced using the soft magnetic powder of each sample No., an electrical resistance value was measured by the method shown below.

First, a lower punch electrode was set at a lower end in a columnar cavity having an inner diameter of 8 mm in a mold. Next, the cavity was filled with the soft magnetic powder (0.7 g). Next, an upper punch electrode was set at an upper end in the cavity. The mold, the lower punch electrode, and the upper punch electrode were set in a load applying device. Next, a load of 20 kgf was applied, using a digital force gauge, in a direction in which a distance between the lower punch electrode and the upper punch electrode was shortened. Then, an electrical resistance value between the lower punch electrode and the upper punch electrode was measured in a state in which a load was applied.

Then, the measured electrical resistance value was relatively evaluated in light of the following evaluation criteria. Evaluation results are shown in Tables 1 and 2.
A: the electrical resistance value is particularly high (particularly higher than sample No. 1).
B: the electrical resistance value is high (higher than sample No. 1).
C: the electrical resistance value is slightly high (slightly higher than sample No. 1).
D: the electrical resistance value is lowest (equivalent to sample No. 1).

As shown in Tables 1 and 2, in the soft magnetic powder of each Example, the content of S and the oxygen content A with respect to the specific surface area B are optimized. Therefore, it is confirmed that the green compact produced using the soft magnetic powder of each Example has a high density, correspondingly high magnetic permeability, and a sufficiently high electrical resistance value.

What is claimed is:

1. A soft magnetic powder comprising:
Fe as a main component;
Si having a content of 2.5 mass % or more and 6.5 mass % or less;
Cr having a content of 1.0 mass % or more and 10.0 mass % or less;
S having a content of 0.0020 mass % or more and 0.0070 mass % or less; and
impurities, wherein
a ratio A/B is 3000 or more and 8000 or less, where A [ppm] is an oxygen content in terms of mass ratio and B [m²/g] is a specific surface area.

2. The soft magnetic powder according to claim 1, wherein
the oxygen content A in terms of mass ratio is 1500 ppm or more and 2400 ppm or less.

3. The soft magnetic powder according to claim 1, wherein
an average particle diameter is 1.0 μm or more and 20.0 μm or less.

4. The soft magnetic powder according to claim 1, wherein
the content of Si is 3.0 mass % or more and 4.5 mass % or less, and
the content of Cr is 3.0 mass % or more and 6.0 mass % or less.

5. A dust core comprising:
the soft magnetic powder according to claim 1.

6. A magnetic element comprising:
the dust core according to claim 5.

7. An electronic device comprising:
the magnetic element according to claim 6.
